(19) United States
(12) Patent Application Publication
(10) Pub. No.: US 2022/0155126 A1
(43) Pub. Date: May 19, 2022

(54) MULTI-CAVITY MEASURING SCOOP WITH CLIP

(71) Applicant: Samuel Wechsler, Delmar, NY (US)

(72) Inventor: Samuel Wechsler, Delmar, NY (US)

(21) Appl. No.: 17/526,642

(22) Filed: Nov. 15, 2021

Related U.S. Application Data
(60) Provisional application No. 63/113,416, filed on Nov. 13, 2020.

(51) Int. Cl. G01F 19/00; B65D 33/16

(52) U.S. Cl. CPC G01F 19/002; B65D 33/1658

(57) ABSTRACT

A multi-cavity scoop with a bag clip. The scoop has two ends, each with a different volume for measuring goods. The clip portion of the device can then be used to seal the bag and retain the scoop in a convenient location with the goods to be distributed with the scoops. The device could include even more scoops of any necessary volume or shape. The clip could include a spring for clamping down onto the packaging of the goods to be distributed with the scoops.

### CROSS-REFERENCE TO RELATED APPLICATION

This application claims priority in U.S. Provisional Patent Application No. 63/113,416 Filed Nov. 13, 2020, which is incorporated herein by reference.

### BACKGROUND OF THE INVENTION

### 1. Field of the Invention

The present invention relates generally to measurement scoops and method for use thereof, and more specifically to a multi-volume measurement scoop with bag sealing clip.

### 2. Description of the Related Art

Many packages of dry goods or other goods come with scoops for distributing the contents of a package. It is desirable to measure with multiple cavities and seal a bag because one may need to measure material and seal a bag. Customized scoops sold alone for use with dry goods and other goods also provide various levels of volume measurement. However, these scoops typically have a single volume measurement and function only as scoops.

Heretofore there has not been available a system or method for a multi-volume measurement scoop with bag sealing clip with the advantages and features of the present invention.

### BRIEF SUMMARY OF THE INVENTION

The present invention generally provides a multi-cavity scoop with a bag clip. The scoop has two ends, each with a different volume for measuring goods. The clip portion of the device can then be used to seal the bag and retain the scoop in a convenient location with the goods to be distributed with the scoops. The device could include even more scoops of any necessary volume or shape. The clip could include a spring for clamping down onto the packaging of the goods to be distributed with the scoops.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention.

FIG. 2 is another three-dimensional isometric view thereof.

FIG. 3 is a bottom plan view thereof.

FIG. 4 is a front elevational view thereof.

FIG. 5 is a side elevational view thereof.

FIG. 6 is a rear elevational view thereof.

FIG. 7 is a top plan view thereof.

FIG. 8 is a three-dimensional view showing the embodiment thereof in a typical environment about a storage device.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Multi-Volume Scoop and Clip 2

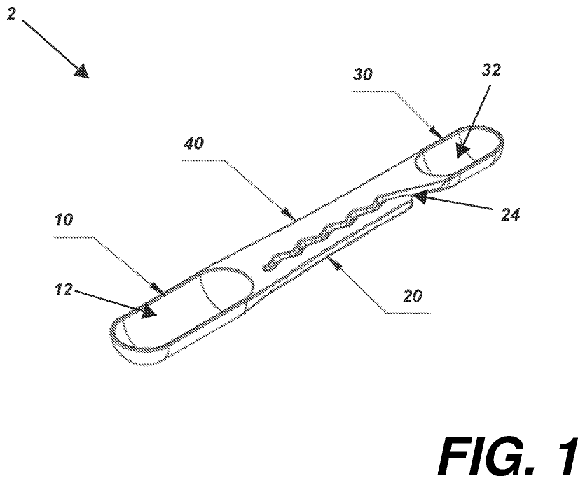

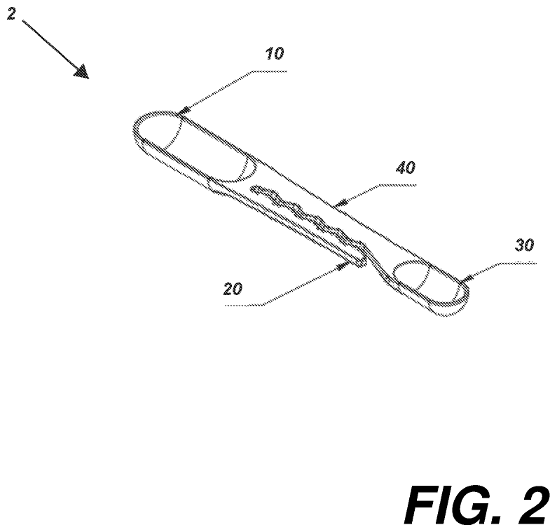

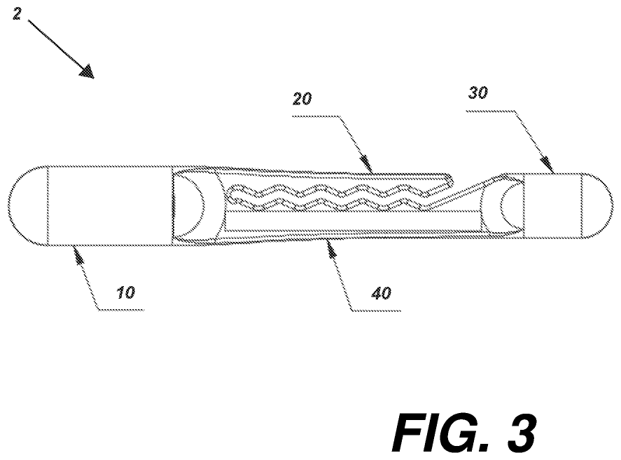

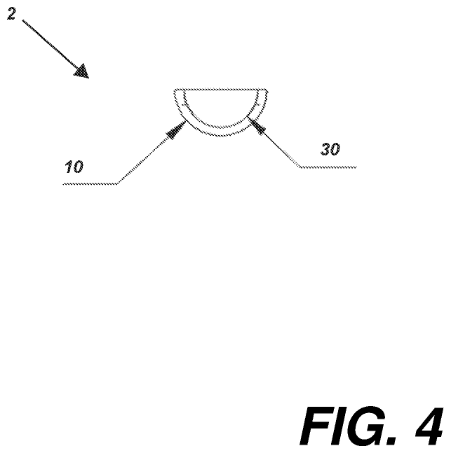

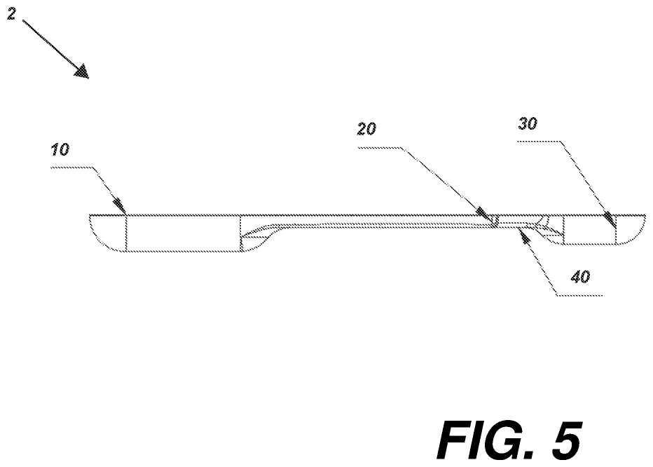

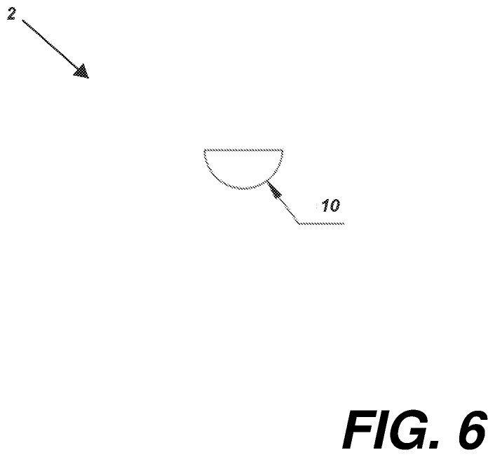

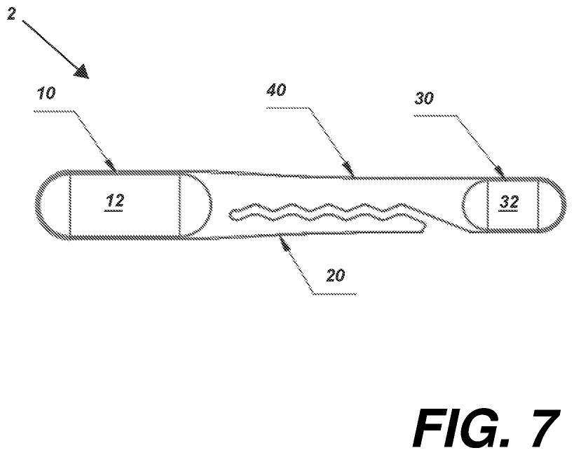

As shown in FIGS. 1-7, the present invention is a multi-cavity measuring scoop with clip 20. A first end has a first scoop 10 has with a first volume 12 and a second end has a second scoop 30 with a second volume 32. A handle body 40 connects the two scoops and also functions as half of the clip for helping to retain the scoop onto a bag or other storage container.

As shown the clip 20 is separated from the remainder of the handle 40 via a space. Here, the space is shown in a zig-zag pattern to help secure the clip 20 to a bag or other connected body. A tapered opening 24 helps to guide the clip 20 onto the bag.

The measuring device is held by the handle and pushed into a material, cavity-end 12, 32 first. The user may elect to push the scoop into the material so that all measuring cavities are filled, or only one cavity is filled. With the multiple cavities, the user may elect to measure with any sum of combinations of the cavities. The user may then dispense the material from one or more cavities. The user may use the clip 20 to seal a bag by sliding the bag, folded or unfolded in the space 22 between the clip 20 and the handle 40. The user may also use the clip to seal the bag through other means, such as rolling the bag up with the handle 40 with or without the clip 20 engaging the bag.

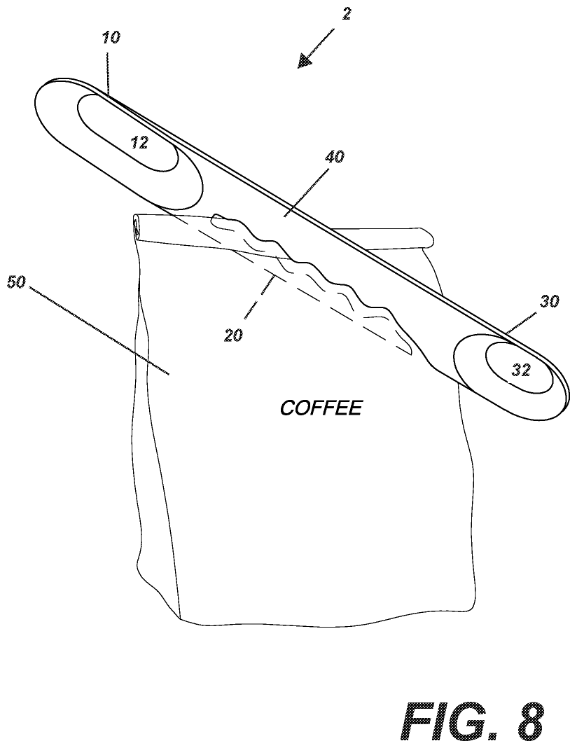

FIG. 8 shows how the measuring device 2 may be stored on a storage device 50, such as a bag of coffee, to both secure the storage device in a closed orientation and to keep the cavities 12, 32 close by and ready to scoop material from the storage device. The clip 20 clamps against the storage device 50 and the handle 40 to secure the measuring device 2 to the storage device 50.

An alternative use is to pour the material into each cavity.

The measuring cavities may be on the same plane, so that they break the same plane, or they may be on opposing planes, to break different planes, or may break any plane or planes, or may be offset.

It should further be noted that the invention may be made of plastic, silicone, metal, wood, ceramic, or other material. It may be made via 3D printing, milling, sintering, stamping, bending, casting, forging, injection molding, or other means.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A tool comprising:
a first end ending in a first scoop having a first volume;
a second end ending in a second scoop having a second volume;
said first volume and said second volume not being equal;
a handle joining said first end to said second end; and
a clip connected to said handle, said clip configured to retain the tool onto a storage device.

2. The tool of claim 1, further comprising:
said clip having a proximal end and a distal end;
said distal end of said clip permanently affixed to said handle;
said proximal end of said clip permanently free and non-affixed to said handle; and
a space formed between said clip and said handle, said space configured to receive said storage device.

3. The tool of claim 2, further comprising:
said clip having an interior tooth-like structure facing a corresponding tooth-like structure of said handle; and
said space existing between said interior tooth-like structure of said clip and said corresponding tooth-like structure of said handle.

4. The tool of claim 2, wherein said distal end of said clip engaged with said handle provides a spring-like relationship between said clip and said handle such that said clip is configured to clamp down against said handle about said storage device.

5. The tool of claim 1, wherein said first scoop, said second scoop, said handle, and said clip are all formed from a single mold.

6. The tool of claim 1, wherein said first volume and said second volume are configured to be filled with a material stored within said storage device.

7. The tool of claim 1, wherein said storage device is a bag.

8. A method of utilizing a tool about a storage device, the method comprising the steps:
providing a tool comprising a first end ending in a first scoop having a first volume, a second end ending in a second scoop having a second volume, a handle joining said first end to said second end, and a clip connected to said handle;
wherein said first volume and said second volume are not equal;
closing a storage device;
engaging said storage device with said clip, such that said clip retains said tool onto said storage device while rendering said storage device closed;
removing said tool from said storage device;
selecting a preferred scoop amongst said first scoop and said second scoop;
opening said storage device;
removing material stored within said storage device with said preferred scoop;
deploying said material from said preferred scoop;
closing said storage device; and
securing said tool to said storage device via said clip.

9. The method of claim 8, wherein:
said clip having a proximal end and a distal end;
said distal end of said clip permanently affixed to said handle;
said proximal end of said clip permanently free and non-affixed to said handle; and
a space formed between said clip and said handle, said space configured to receive said storage device.

10. The method of claim 9, wherein:
said clip having an interior tooth-like structure facing a corresponding tooth-like structure of said handle; and
said space existing between said interior tooth-like structure of said clip and said corresponding tooth-like structure of said handle.

11. The method of claim 9, wherein said distal end of said clip engaged with said handle provides a spring-like relationship between said clip and said handle such that said clip is configured to clamp down against said handle about said storage device.

12. The method of claim 8, wherein, wherein said first scoop, said second scoop, said handle, and said clip are all formed from a single mold.
